(19) United States
(12) Patent Application Publication
(10) Pub. No.: US 2026/0201742 A1
(43) Pub. Date: Jul. 16, 2026

(54) SENSOR UNIT FOR A DOOR DRIVE

(71) Applicant: dormakaba Deutschland GmbH, Ennepetal (DE)

(72) Inventors: Torsten DÜNNINGHAUS, Ennepetal (DE); Patrick VOLP, Ennepetal (DE); Bernhard HEITZ, Ennepetal (DE); Jonas BUEHREN, Ennepetal (DE)

(21) Appl. No.: 19/444,920

(22) Filed: Jan. 9, 2026

(30) Foreign Application Priority Data
Jan. 13, 2025 (EP) 25151602.7

(51) Int. Cl. E05F 15/70; G07C 9/22

(52) U.S. Cl. CPC E05F 15/70; G07C 9/22

(57) ABSTRACT

A sensor unit for a door drive, having at least one first and one second housing, with each housing having at least one profile for receiving sensors and/or control units which are covered by way of at least one cover, with the housings being completely separated from one another and being able to be arranged facing each other by way of a separating wall.

### CROSS-REFERENCE TO RELATED APPLICATIONS

This application claims the benefit of European patent application no. 25151602.7, filed on 13 Jan. 2025, the disclosure of which is incorporated herein by reference in its entirety.

### TECHNICAL FIELD

The disclosure relates to a sensor unit for a door drive according to the preamble of the independent claim.

### BACKGROUND

Door drives per se are well known. They can comprise sliding leaves in the form of door leaves, window leaves or separating wall modules, which are guided at the top by means of carriages along a predetermined, usually linear, travel path. The carriages are guided on a guide rail, which in turn can be accommodated in a housing that is open in the direction of the sliding leaf. Rotating leaf doors are actuated via a linkage that is set in a rotary motion by means of a motorised drive.

If the door system can be operated automatically, i.e. is provided with a motorised drive, sensors are provided to secure the passage region of the door system and/or to ensure operation. There are also sensors present that are designed to detect a person intending to pass through the door system. The sensors record the immediate environment of the door system and correspond with the control system of the door system, which is designed to open and close the door such that injuries to the user of the door at the main and secondary closing edges are avoided. The sensors are arranged placed on the housing in a known manner, which can look unattractive. This also requires a special design of the housing for attaching the sensors.

EP 3910145 A1 discloses a sliding door drive with a base body in which at least one motor-driven carriage is arranged to receive a sliding leaf. The base body has an at least partially closed housing in which a sensor unit for environment detection is arranged. In one partial region of the housing is integrated a sensor disc which extends over the entire length of the housing.

This makes it difficult to use sensors with different frequency ranges and wavelengths, as they require sensor discs with different permeability for the respective wavelengths of the sensor beams in order to be fully functional. The return of the beams can also lead to incorrect information at the receivers or the associated control systems, which can occur more frequently with sensor beams with different frequency ranges.

### SUMMARY

The present disclosure creates a sensor unit for a door drive which eliminates the above-mentioned disadvantages.

This is achieved by proceeding from a sensor unit for a door drive according to the preamble of the independent claim in conjunction with the characterising features. Advantageous further developments of the disclosure are indicated in the dependent claims.

The disclosure includes the technical teaching that the sensor unit has at least one first and one second housing, with each housing having at least one profile for receiving sensors and/or control units, which are covered by means of at least one cover. The housings are completely separated from each other and can be arranged facing each other by means of a separating wall. This enables a modular design of the sensor unit, in which different sensors can be combined in separate housings and adjusted to the monitoring of a door drive. The housings are connected to each other at the end face in the longitudinal alignment of the sensor unit, with the separating wall at least partially assuming a connecting function between the housings.

Each cover can have a sensor disc which is designed to allow the electromagnetic waves of the sensors to pass through, with the sensor disc of the first housing being able to differ from the sensor disc of the second housing in the permeability of the electromagnetic waves. The term electromagnetic waves is used below to summarise radar waves, light waves, infrared waves and ultrasonic waves. This has the advantage that when using sensors with different radiation frequencies and wavelengths, the transparency of the associated sensor disc can also be adjusted. Sensor discs made of plastic material, in particular acrylic glass, are preferably used, the thickness of which is adjusted to the different wavelengths of the sensors. This results in a modular design of the sensor housing with completely separate housing parts that can be fitted with different sensors and whose covers differ in the thickness of the plastic material due to the different sensor discs.

The modular design of the sensor housing with at least two completely separate housings enables the door drive to be retrofitted with sensors in a different frequency range and wavelength. At the same time, this also makes maintenance easier, as a complete first or second housing with the associated sensors can be replaced on site and only verified in the workshop. This ensures that the door functions more quickly. A further advantage is that the first and second housing can be manufactured independently of each other, since different materials or different material thicknesses are used at least for the cover with the sensor discs, which is very expensive, inflexible in use and prone to errors in the case of integrated production of a single cover with different sensor discs.

At least one sensor, whose frequency range and wavelength differs from the at least one sensor of the second housing, can be arranged in the first housing. At least one sensor for environmental monitoring can preferably be arranged in one housing, and at least one sensor for person identification can be arranged in another housing. The sensor for person identification can be used as an option depending on the installation location of the door and can also be retrofitted later if necessary.

The separating wall can be designed to separate the electromagnetic waves of the sensors or their receivers between the first and second housing. To ensure that the receivers of the sensors receive a clear signal due to the feedback of the different radiation frequencies and wavelengths, the separating wall serves as a shield for the different radiation frequencies and wavelengths used in the separately designed housings. The separating wall therefore has a shielding effect for electromagnetic waves and can be made, for example of steel, aluminium or preferably a plastic material that shields against electromagnetic waves.

Each housing preferably consists of a U-shaped profile to which the cover is detachably fastened. The profiles can be cut to length from a continuous cast profile in accordance with a standardised housing length, depending on the sensor unit used. The associated cover is adjusted to the housing length and the permeability of the sensor disc. The sensor disc can extend from a front vertical part of the cover by means of a radius or chamfer into a horizontal section and enables the sensor to record the front frontal region of the door, as well as the region of the floor. The sensor disc can be arranged between an upper vertical and a lower horizontal region, neither of which consists of the material of the sensor disc. The sensor disc can thus be integrated into the cover as a single piece, creating a uniform design without protruding edges or transitions for the sensor unit.

Each profile can preferably have at least one fastening element onto which a base plate or a carrier with the sensors can be placed. This enables the housings to be assembled quickly.

Because the separating wall has fastening elements that are designed as pins or latching lugs that correspond to openings in the end faces of the profiles, the separating wall can at least partially fulfil a connecting function between the housings.

The outer end faces of the housings are closed by cover caps, which have fastening elements in the form of pins, latching lugs or screws that correspond to openings in the end faces of the profiles. The openings in the end faces of the profiles are designed to receive both the fastening elements of the separating wall and the fastening elements of the cover caps. The standardised design of the cover caps and the separating wall also serves to facilitate the modular design of the sensor unit.

The sensor unit can have a plurality of first housings and at least one second housing, which are arranged facing each other in the longitudinal extension and are connected to each other by a separating wall in each case. For example, a first housing with the associated sensors for environmental monitoring can be used for each main and secondary closing edge, with a second housing with a sensor for person identification being able to be arranged on the left or right end face of a first housing.

The first housing and the second housing can differ in the size of the longitudinal extension, as the sensors to be received are different.

The modular design of the sensor unit offers the variability to combine the first and second housings in any arrangement and number in the longitudinal extension. The sensor unit according to the disclosure can thus be flexibly adjusted and used on door systems with different door widths and door leaves.

The sensor unit can therefore be combined with a sliding door drive or a rotating leaf drive. The arrangement can take place on the wall or the lintel, which is arranged on the opposing side of the lintel to where the door drive is arranged.

### BRIEF DESCRIPTION OF THE DRAWINGS

Further measures that improve the disclosure will be outlined in greater detail below together with the description of a preferred exemplary embodiment of the disclosure on the basis of the figures, for which is shown:

FIG. 1 a perspective representation of the sensor unit,

FIG. 2 a perspective representation of the sensor unit with the cover removed,

FIG. 3 a side representation of the sensor unit in FIG. 2,

FIG. 4 a representation of a sensor unit with a plurality of housings.

### DETAILED DESCRIPTION OF THE DRAWINGS

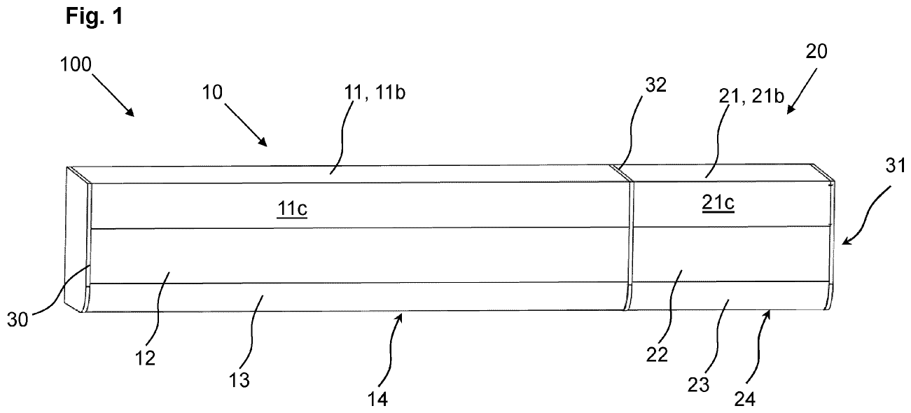

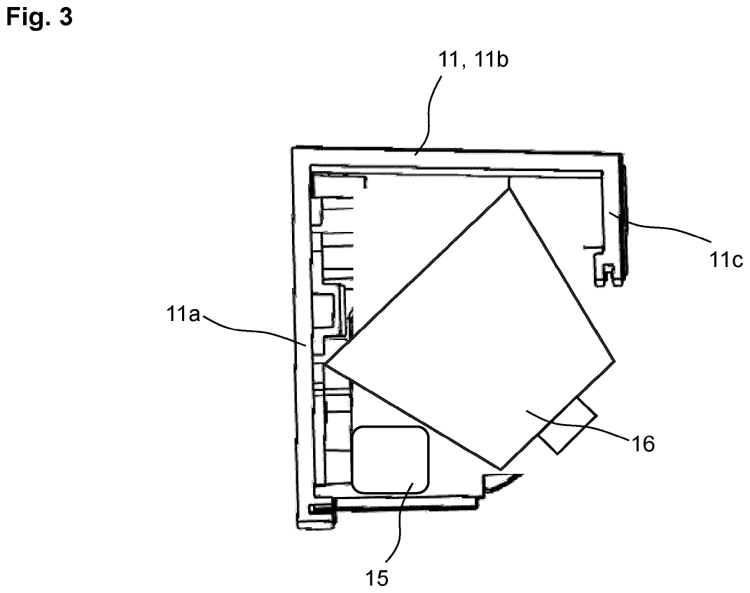

FIG. 1 shows a perspective view of the sensor unit 100 of a sliding door drive, which comprises a first and a second housing 10, 20. Each housing 10, 20 consists of its own angled profile 11, 21, on or in which a control unit 15 and sensors 16, 25 are arranged. Each profile 11, 21 (FIG. 3) is substantially U-shaped, with the front vertical leg 11c, 21c aligned to the user of the door being shorter than the rear vertical leg 11a, 21a, which are connected by a horizontal upper leg 11b, 21b. At least one part of the front side and underside of the sensor unit 100 is covered by covers 12, 22, which are detachably fastened to the profiles 11, 21 in a form-fit or force-fit manner, for example. Each cover 12, 22 comprises at least one sensor disc 13, 23 which merges from the front perpendicular part of the cover 12, 22 into a horizontal section 14, 24 with a radius or chamfer. The first and second housings 10, 20 are completely separate housing parts which can be joined together by means of a separating wall 32 and fastened to a wall not represented or to a lintel or transom. The separating wall 32 extends completely through the cross-section of the profiles 11, 21 and for the associated end face forms a lateral closure for each profile 11, 21 or for each housing 10, 20. The outer end faces of the housings 10, 20 are closed by cover caps 30, 31. In the case of a different arrangement of the housings 10, 20, the end faces of the profiles 11, 21 can also be closed by cover caps 30, 31 instead of by the separating wall 32. The modular design of the sensor unit allows the separating wall 32 or the cover caps 30, 31 to be used as required to close the end faces of the profiles 11, 21 or the housings 10, 20. Both the separating wall 32 and the cover caps 30, 31 have fastening elements 30a, 31a, 32a, which correspond to the same end-face openings in the profiles 11, 21. In cross-section, the housings 10, 20 have a rectangular profile or cross-section, with the lower region arranged facing the user of the door being rounded off by the sensor discs 13, 23. In this exemplary embodiment, the first housing 10 has a significantly greater longitudinal extension than the second housing 20.

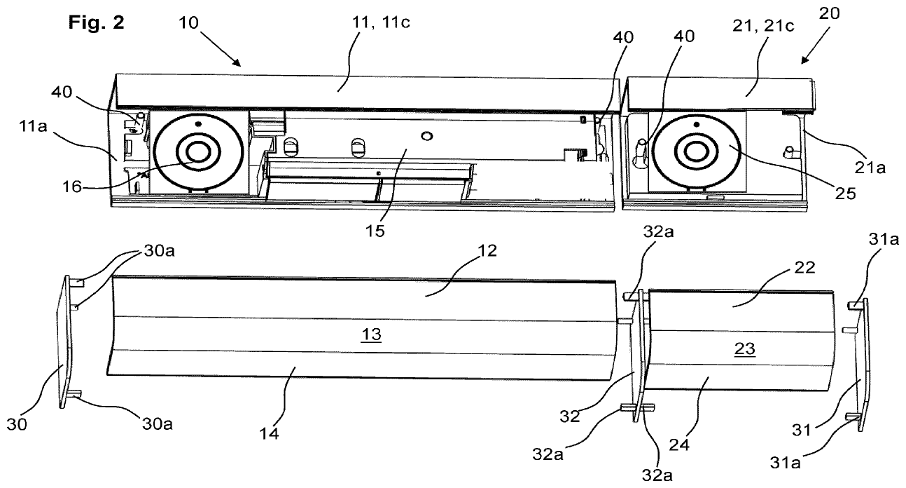

In FIG. 2, the housings 10, 20 are represented open by removing the covers 12, 22 and the cover caps 30, 31 with the separating wall 32. It can be seen here that the separating wall 32 completely separates the two adjoining end faces of the profiles 11, 21 from one another and extends over the entire cross-section of the profiles 11, 21. The first housing 10 shows a radar sensor 16 with a receiver not represented and a further control unit 15, which are arranged on and in the profile 11. The control unit 15 can have a further infrared sensor with a transmitter and receiver unit. It is also possible to use a sensor assembly that has an integrated radar and infrared sensor with receiver and other sensors (light sensors, ultrasonic sensors) for environmental monitoring or evaluation.

The first housing 10 can, for example, be fastened to a wall not represented or to a lintel or transom using fastening elements, with the associated door drive being able to be arranged on the other side of the opening of the door. An arrangement of the housing 10 on the lintel or transom, to which the door drive is fastened, is also possible. On the profile 11 of the first housing 10 are arranged fastening elements 40, onto which the sensors and control unit 15 can be placed and fastened by means of a carrier or a base plate. The radar sensor 16 represented here can be aligned with a main or secondary closing edge of the door by rotating it. In this exemplary embodiment, the second housing 20 is significantly shorter in the longitudinal extension than the first housing 10 and can also be fastened to a wall or a lintel on a transom independently of the first housing 10. On this profile 21 are also arranged fastening elements 40, by means of which a carrier or a base plate, on which the sensor assembly 25 is fastened, can be placed and fastened. The sensor assembly 25 can also be designed to be set in its inclination towards the entrance region of the door.

FIG. 3 shows the first housing 10 from the left end face, in which the cross-section of the profile 11 with the rear vertical leg 11a, the horizontal upper leg 11b and the front vertical leg 11c can be seen. On the vertical legs 11a, 11c are shown openings which are not labelled further and into which the cover 12 can be detachably fastened.

Between the first and the second housing 10, 20 is arranged a separating wall 32, which has fastening elements 32a on both sides, for example in the form of pins, latching lugs or screws, and correspond to openings in the end faces of the profiles 11, 21 arranged on both sides. Depending on the embodiment of the fastening elements 32a, it is also possible to dispense with the rear fastening to the wall or lintel for the second, shorter housing 20. The left and right cover caps 30, 31 also have associated fastening elements 30a, 31a in the form of pins, latching lugs or screws, which correspond to end-face openings in the profiles 11, 21.

The sensor or sensors 16 with the associated control unit 15 in the first housing 10 can have a frequency range of, for example, 1 GHz to 40 GHz and can differ from the sensor or sensors 25 in the second housing 20 in the frequency range, which is, for example, in the frequency range above 40 GHz to 80 GHz. To ensure that the receivers of the sensors receive a clear signal due to the feedback of the different radiation frequencies and wavelengths, the separating wall 32 serves as a shield for the different radiation frequencies and wavelengths (radar waves, light waves, infrared waves, ultrasonic waves, etc.) used in the separately designed housings 10, 20. The separating wall 32 therefore has a shielding effect for electromagnetic waves (radar waves, light waves, infrared waves, ultrasonic waves, etc.) and can be made, for example of steel, aluminium or preferably a plastic material that shields against electromagnetic waves. For example, the radar sensor 16 in the first housing 10 can be designed to detect a user of the door by the decreasing distance to the door and open it automatically. The sensor assembly 25 in the second housing 20 can be designed to detect whether a person is approaching the door or walking past the door (person identification). This sensor assembly 25 can be designed with a self-learning control system that analyses the behaviour of users of the door and, based on the data recorded for this installation position in the building, decides independently whether the potential user is only walking too close past the door or wants to pass through the door opening (AI).

The data connection of the sensor assembly 25 and the sensors 16 with the sensor control system 15 to the control system of the door drive takes place via data lines, not represented, which are routed through the rear of the profiles 11, 21 and/or through a small breakthrough in the separating wall 32 and can be designed with plug-in contacts. The sensor assembly 25 and the sensors 16 can also be supplied with power by the sensor control system 15 via cables through the rear of the profiles 11, 21 and/or through a small breakthrough in the separating wall 32 to the door drive by means of plug-in contacts.

With regard to the different radiation frequencies and wavelengths of the sensors, the transparency of the associated sensor disc 13, 23 in the cover 12, 22 is also adjusted. A sensor disc 13, 23 made of plastic material, for example acrylic glass, is preferably used, the thickness of which is adjusted to the different wavelengths of the sensors 16, 25. This results in a modular design of the sensor housing 100 with completely separate housing parts that can be fitted with different sensors and whose covers 12, 22 differ in the thickness and permeability of the electromagnetic waves of the sensor disc due to the different sensor discs 13, 23. This has the further advantage that, with a different arrangement of the main closing edge of the door, the second housing 20—here designed to be short in length—can be arranged both on the right and on the left end edge of the first housing 10. The separating wall 32 is also used to separate the electromagnetic waves of the sensors or their receivers between the two housings 10, 20. The separating wall 32 can be replaced by a cover 30, 31 if a different arrangement of the housings 10, 20 is required. The right cover cap 31, which closes the right end face of the second housing 20 in FIG. 2, is then used for the right end face of the first housing 10. The left cover cap 30, which closes the left end face of the first housing in FIG. 2, is then used for the left end face of the second housing 20.

The modular design of the sensor housing 100 with at least two completely separate housings 10, 20 enables the door drive to be retrofitted with sensors in a different frequency range and wavelength (radar waves, light waves, infrared waves, ultrasonic waves, etc.). At the same time, this also makes maintenance easier, as a complete first or second housing 10, 20 with the associated sensors can be replaced on site and only verified in the workshop. This ensures that the door functions more quickly. A further advantage is that the first and second housing 10, 20 can be manufactured independently of each other, since different materials are used at least for the cover 12, 22, which is very expensive, inflexible in use and prone to errors in the case of integrated production of a single cover with different sensor discs. Depending on the sensor used, a different cover with an adjusted sensor disc can be used.

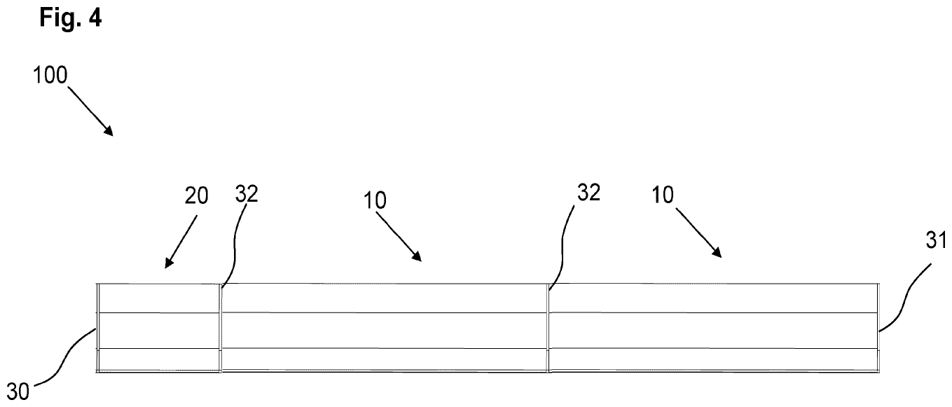

FIG. 4 shows a variant of a modular design of the sensor unit 100, which here consists of two first housings 10 connected at the end face. The aforementioned separating wall 32, which connects the profiles 11 of the two housings 10, is arranged between the first housings 10. The right end face of the right first housing 10 is covered with a right cover cap 31. On the left end face of the left first housing 10 is arranged the second housing 20, which in turn is arranged with a separating wall 32 on the end face of the left first housing 10. The left end face of the second housing 20 is again closed with a cover cap 30. Depending on the design and the need to monitor the environment, a plurality of housings 10, 10, 20 can be arranged and combined in any desired arrangement at the end face to form a sensor unit 100. Each housing 10, 10, 20 can have sensors with different frequency ranges, which are shielded from each other by a separating wall 32. The associated cover 12, 22 with the sensor discs 13, 23, whose radiation permeability can vary, is then also adjusted to the frequency range of the sensors. For example, for a two-leaf sliding door, three first housings 10 can be used, which serve to secure two secondary closing edges and one main closing edge. These three first housings 10 can be supplemented by one or two second housings 20 at the end face, which are used for person identification, for example. Alternatively, one or a plurality of second housings 20 can also be arranged between the first housings 10. In addition to the modular design of the sensor unit 100 and the separation of the individual housings 10, 20 by a separating wall 32, the advantage of the disclosure lies in the assignment of the sensor discs to the sensor used, the radiation permeability of which is adjusted to the frequency range and the wavelength of the sensors.

The separating wall 32 extends completely through the cross-section of the profiles 11, 21 and for the associated end face forms a lateral closure for each profile 11, 21 or for each housing 10, 20. The outer end faces of the housings 10, 20 are closed by cover caps 30, 31. In the case of a different arrangement of the housings 10, 20, the end faces of the profiles 11, 21 can also be closed by cover caps 30, 31 instead of by the separating wall 32. The modular design of the sensor unit allows the separating wall 32 or the cover caps 30, 31 to be used as required to close the end faces of the profiles 11, 21 or housings 10, 20. Both the separating wall 32 and the cover caps 30, 31 have fastening elements 30a, 31a, 32a, which correspond to the same end-face openings in the profiles 11, 21.

The design of the disclosure is not restricted to the preferred exemplary embodiment indicated above. In fact, a number of variants is conceivable which make use of the represented solution even in the case of fundamentally different designs. All features and/or advantages emerging from the claims, the description or the drawings, including constructive details or spatial arrangements, may be essential to the disclosure by themselves and in the most varied combinations.

1. A sensor unit for a door drive, having at least one first and one second housing, wherein each housing has at least one profile for receiving sensors and/or control units which are covered by way of at least one cover, wherein the housings are completely separated from one another and can be arranged facing each other by way of a separating wall.

2. The sensor unit according to claim 1,
wherein each cover has a sensor disc which is designed to allow the electromagnetic waves of the sensors to pass through, wherein the sensor disc of the first housing differs from the sensor disc of the second housing in the permeability of the electromagnetic waves.

3. The sensor unit according to claim 1,
wherein at least one sensor, whose frequency range and wavelength differs from the at least one sensor of the second housing, is arranged in the first housing.

4. The sensor unit according to claim 3,
wherein at least one sensor for environmental monitoring is arranged in one housing, and at least one sensor for person identification is arranged in another housing.

5. The sensor unit according to claim 1,
wherein the separating wall is designed to separate the electromagnetic waves of the sensors or their receivers between the first and second housing.

6. The sensor unit according to claim 1,
wherein each housing consists of a substantially U-shaped profile to which the cover is detachably fastened.

7. The sensor unit according to claim 2,
wherein each cover has a sensor disc which merges from the front vertical part of the cover into a horizontal section by way of a radius or chamfer.

8. The sensor unit according to claim 1,
wherein each profile has at least one fastening element on which a base plate or a carrier with the sensors can be arranged.

9. The sensor unit according to claim 1,
wherein the separating wall has fastening elements which are designed as pins, latching lugs, or screws which correspond to openings in the end faces of the profiles.

10. The sensor unit according to claim 1,
wherein the outer profiles of the housings are closed at their outer end faces by cover caps which have fastening elements in the form of pins, latching lugs, or screws which correspond to openings in the end faces of the profiles.

11. The sensor unit according to claim 9,
wherein the openings in the end faces of the profiles are designed to receive both the fastening elements of the separating wall and the fastening elements of the cover caps.

12. The sensor unit according to claim 1,
wherein the sensor unit has a plurality of first housings and at least one second housing, which are arranged facing each other and are connected to each other by a separating wall in each case.

13. The sensor unit according to claim 1,
wherein the first housing and the second housing differ in the longitudinal extension.

14. The sensor unit according to claim 1,
wherein the arrangement of the at least one first housing and the at least one second housing is variable in longitudinal extension.

15. The sensor unit according to claim 1, for use with a sliding door drive or with a rotating leaf drive.
